(19) United States
(12) Patent Application Publication
(10) Pub. No.: US 2009/0289811 A1
(43) Pub. Date: Nov. 26, 2009

(54) DISPLAY SYSTEM AND VEHICLE HAVING THE SAME

(75) Inventor: TAI-HSU CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/337,747

(22) Filed: Dec. 18, 2008

(30) Foreign Application Priority Data
May 21, 2008 (CN) 200810301691.3

(51) Int. Cl. G08G 1/00; H04N 7/18

(52) U.S. Cl. 340/901; 348/148; 348/E07.085

(57) ABSTRACT

A display system for a vehicle includes an image capture module, a projecting panel and a stereoscopic projection device. The image capture module is configured for mounting on a vehicle and capturing an image of the traffic to the rear of the vehicle. The projecting panel is configured for being positioned in front of a driver's seat in the vehicle. The stereoscopic projection device is configured for projecting a stereo image of the captured image on the projecting panel.

### BACKGROUND

1. Field of the Disclosure

The present disclosure generally relates to display systems, and particularly to a display system providing a stereo image for a driver in a vehicle, and a vehicle utilizing the display system.

2. Description of Related Art

With developments in automotive technology, performance, aerodynamics, and safety have been geared to meet desires of consumers. Rearview mirrors used in automobiles are an important feature, allowing the driver to see the area to the rear of vehicle through the back windows.

However, many rearview mirrors are difficult to see and provide only limited vision for the driver, leaving much room for improvement.

What is needed, therefore, is an improved display system which can overcome the limitations described.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present display system. Moreover, in the drawings, like reference numerals designate corresponding parts throughout the several views.

FIG. 1 is a schematic, side view of a vehicle with a display system according to a first embodiment.

FIG. 2 is a schematic, top view of a vehicle with a display system according to a second embodiment.

FIG. 3 shows an alternative embodiment of a vehicle with a display system.

### DETAILED DESCRIPTION OF EMBODIMENTS

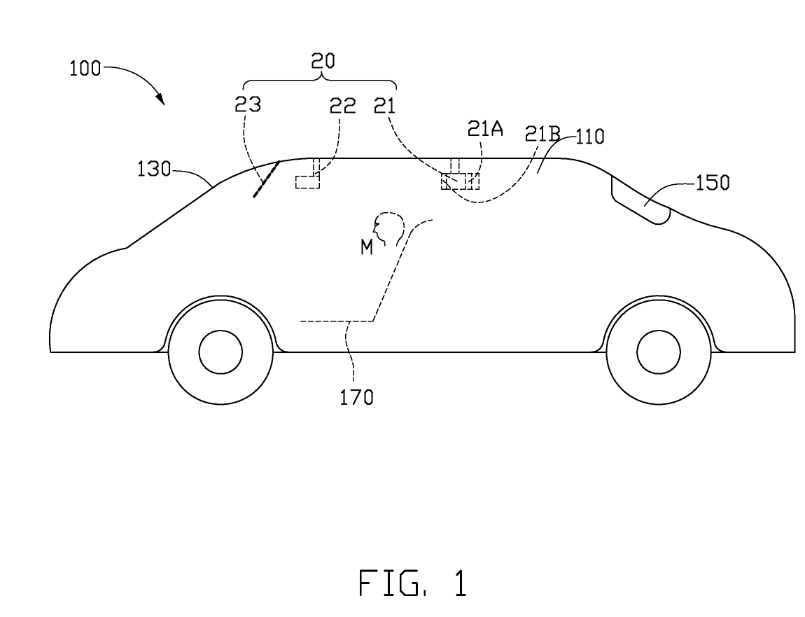

A display system for use in a vehicle is disclosed. Referring to FIG. 1, a display system 20, in accordance with the disclosure, is shown, here, installed on a vehicle 100. The display system 20 includes an image capture module 21, a stereoscopic projection device 22 and a projecting panel 23.

The vehicle 100 includes a compartment 110, a windshield 130, a rear window 150 and a seat 170 adjacent to the windshield 130. The image capture module 21 is mounted on an inner ceiling of the compartment 110. Generally, the image capture module 21 can be a camera module facing the rear window 150. The camera module 21 includes a lens 21A and an image sensor 21B. Light from objects (such as other vehicles) to the rear of compartment 110 enters through the rear window 150 and the lens 21A to reach image sensor 21B. The image sensor 21B detects the light and forms a corresponding image and generates a detected signal of the image, provided to the camera module 21. Image sensor 21B can be a charge-coupled system (CCD) or a complementary metal oxide semiconductor system (CMOS).

The stereoscopic projection device 22 is mounted on the inner ceiling of the body 110 adjacent to the windshield 130, and is electrically connected to the image capture module 21, receiving the detected signal therefrom. The projecting panel 23 is positioned above the seat 170 of the vehicle 100 facing the stereoscopic projection device 22. Here, the projecting panel 23 is a white board disposed between the windshield 130 and the stereoscopic projection device 22. The stereoscopic projection device 22 projects a stereo image of the signal to the projecting panel 23 upon receipt of same. A driver M on the seat 170 can accurately monitor the area and conditions to the rear of vehicle 100. The lens 21A can be a wide-angle lens providing a wider field of traffic.

A vehicle 100 employing the first embodiment 20 of the display system is also disclosed, as shown in FIG. 1.

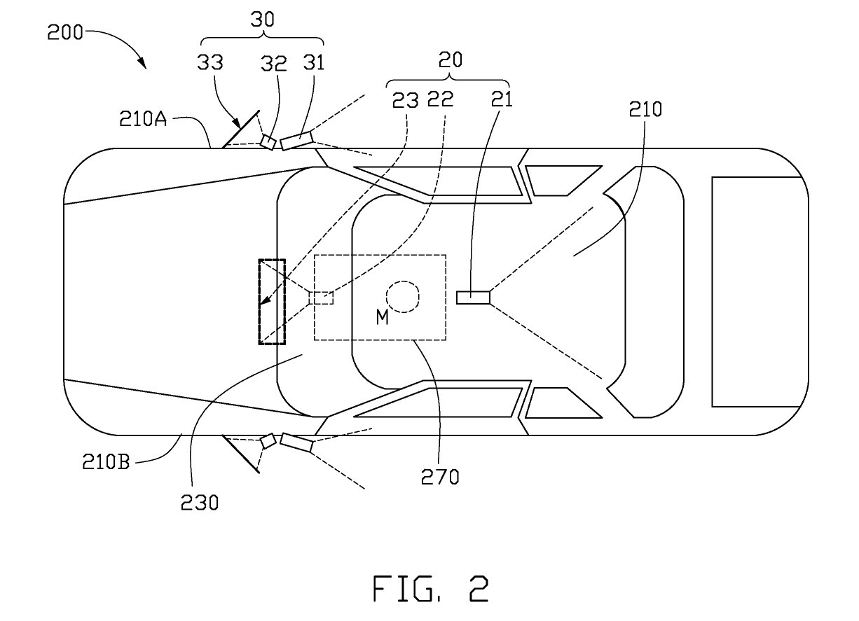

FIG. 2 is a schematic view of a second embodiment of a display system for a vehicle and a vehicle employing the system. The vehicle 200 includes a body 210, a windshield 230, a first display system module 20 and two second display system modules 30.

The first display system module 20 includes a first image capture module 21, a first stereoscopic projection device 22 and a first projecting panel 23 facing the stereoscopic projection device 22. The first stereoscopic projection device 22 is mounted on an inner ceiling of the compartment 210. The first projecting panel 23 is positioned adjacent to the windshield 230 and above a drive's seat 270. The first image capture module 21 is mounted on an outer top of the compartment 210 providing a wider field of the traffic for the driver M.

The two second display system modules 30 each include a second image capture module 31, a second stereoscopic projection device 32 and a second projecting panel 33 facing the second stereoscopic projection device 32. The two second display system modules 30 are arranged on two lateral anterior sides 210A, 210B of the compartment 210. The two second image capture modules 31 capture image of objects on the road at two posterior lateral sides of the compartment 210. The two second projecting panels 33 are positioned at two lateral sides of the driver's seat respectively facing the driver M. The driver M can view road conditions on posterior lateral sides of the compartment 210 through the two second projecting panels 33.

A vehicle 200 employing the first embodiment 20 of the display system is also disclosed, as shown in FIG. 2.

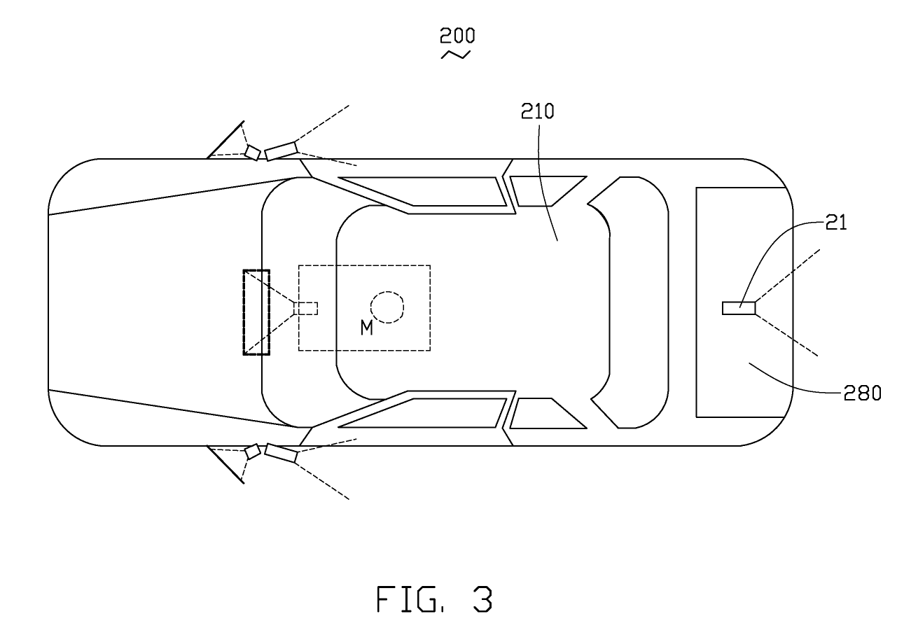

FIG. 3 shows a variation of the second embodiment of a display system for a vehicle and a vehicle employing the variation.

As shown, the first image capture module 21 can be arranged at the rear 280 of the compartment 210, provided that the first image capture module 21 can capture a sufficient range of traffic to the rear of compartment 210 than on the outer top of the compartment 210. Accordingly, arrangement of the first image capture module 21 on the compartment 210 can be varied while remaining well within the scope of the disclosure.

It is believed that the present disclosure and its advantages will be understood from the foregoing description, and it will be apparent that various changes may be made thereto without departing from the spirit and scope of the disclosure or sacrificing all of its material advantages, the examples hereinbefore described merely being preferred or exemplary preferred embodiments of the disclosure.

What is claimed is:

1. A display system for a vehicle, comprising:
an image capture module for mounting on the vehicle and capturing an image of the traffic to the rear of the vehicle;
a projecting panel for being positioned in front of a driver's seat in the vehicle; and
a stereoscopic projection device for projecting a stereo image of the captured image on the projecting panel.

2. The display system of claim 1, wherein the image capture module comprises a lens and an image sensor.

3. The display system of claim 1, wherein the lens is a wide-angle lens.

4. The display system of claim 1, wherein the projecting panel is a white board.

5. A vehicle, comprising:
a compartment;
a driver seat disposed in the compartment; and
a display system comprising
an image capture module for capturing an image of the traffic to the rear of the compartment;
a first projecting panel positioned in the compartment visible from the driver seat; and
a first stereoscopic projection device for projecting a stereo image of the captured image on the first projecting panel.

6. The vehicle of claim 5, wherein the image capture module is mounted on an inner ceiling of the compartment.

7. The vehicle of claim 5, wherein the image capture module is mounted on an outer top wall of the compartment.

8. The vehicle of claim 5, wherein the image capture module is mounted on a rear of the compartment.

9. The vehicle of claim 5, wherein the image capture module comprises a lens and an image sensor.

10. The vehicle of claim 5, wherein the first projecting panel is a white board.

11. The vehicle of claim 5, further comprising two second display system modules arranged at two lateral anterior sides of the compartment, each second display system module including:
a second image capture module for capturing an image of the traffic to the posterior lateral sides of the compartment;
a second projecting panel positioned at the corresponding lateral side;
a second stereoscopic projection device for projecting a stereo image of the captured image on the corresponding second projecting panel.

12. The vehicle of claim 11, wherein the second image capture module comprises a lens and an image sensor.

13. The vehicle of claim 11, wherein the second projecting panel is a white board.
